(19) United States
(12) Patent Application Publication
(10) Pub. No.: US 2007/0051078 A1
(43) Pub. Date: Mar. 8, 2007

(54) Posture correction system

(76) Inventor: Francois Merz, Neuchatel (CH)

Correspondence Address: NIXON & VANDERHYE, PC, 901 NORTH GLEBE ROAD, 11TH FLOOR, ARLINGTON, VA, 22203, US

(21) Appl. No.: 10/574,830

(22) PCT Filed: Nov. 4, 2004
(86) PCT No.: PCT/CH04/00667

§ 371 Date: Apr. 6, 2006

(51) Int. Cl. B68C 5/00; A01K 5/00

(52) U.S. Cl. 54/82

(57) ABSTRACT

Posture ankle boot for horses, characterized in comprising a weight.

The present invention relates to posture correction systems intended primarily, but not necessarily, for horses.

The invention takes the form of a gaiter, characterized in that it comprises a weight.

The weight exerts a force (most often a gravitational force) which acts upon the leg of the horse.

The mass, the orientation and the position of the weight can be modified according to requirements.

Preferably, for a fore posture, the gaiter is placed above the knee. For a hind posture, the gaiter is placed below the hock.

The weight is preferably disposed in a protruding manner on the gaiter, whereby a moment of greater amplitude and of the sort to exert a greater traction upon the leg can be obtained.

The object of the gaiter according to the invention—generally each leg of the horse is provided with such a gaiter—is to provide a balance that the horse has lost in the course of its evolution with the loss of its “fingers”, of which there nowadays remains what are known as the chestnuts. The modern horse has gained speed but lost balance. The present invention offers the possibility of compensating for this imbalance. The horse can regain a balancing tool of which it has been stripped by evolution.

Amongst the various advantages resulting from the invention can be highlighted a reduction in inflammations, an establishment of posture and facilitated musculation.

Work with the gaiter according to the invention can be done on the lunge with a bit, without any other contrivance, by fixing the lunge outside of the lunging direction.

The horse will be able to be “worked” and ridden with the gaiters once it has acquired a musculature and a correct position on the lunge.

The invention will be described in greater detail below by means of examples.

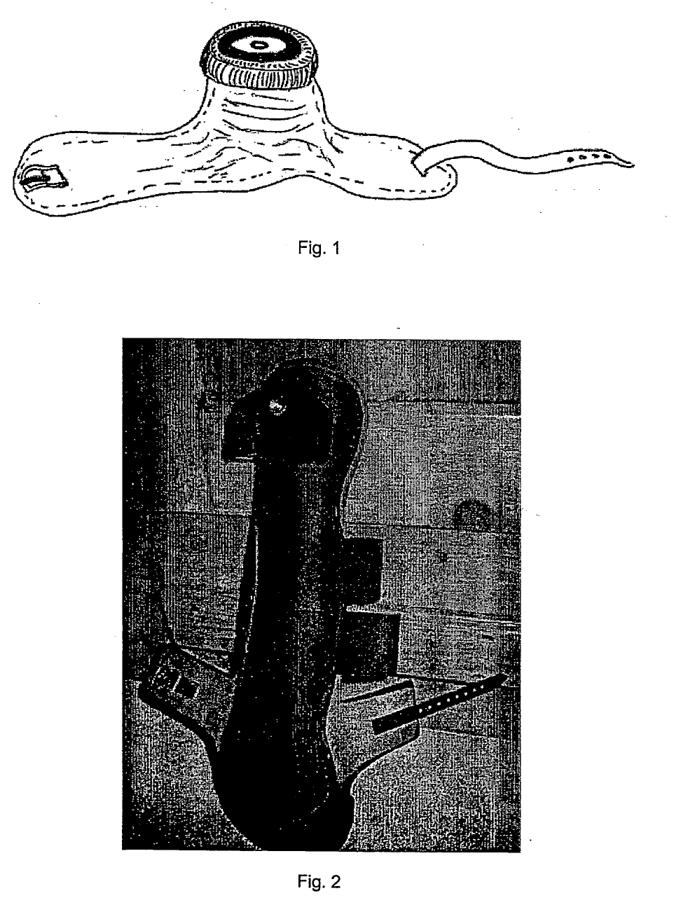

FIGS. 1 to 5 illustrate some non-limiting examples of gaiters according to the invention.

FIG. 6 presents in diagrammatic representation an advantageous orientation of the weights on a horse.

The gaiter illustrated in FIG. 1 can advantageously be used for a fore leg. It is constituted by the actual gaiter, which comprises a fixing system, and by a weight in the form of a protuberance disposed in the center of the gaiter.

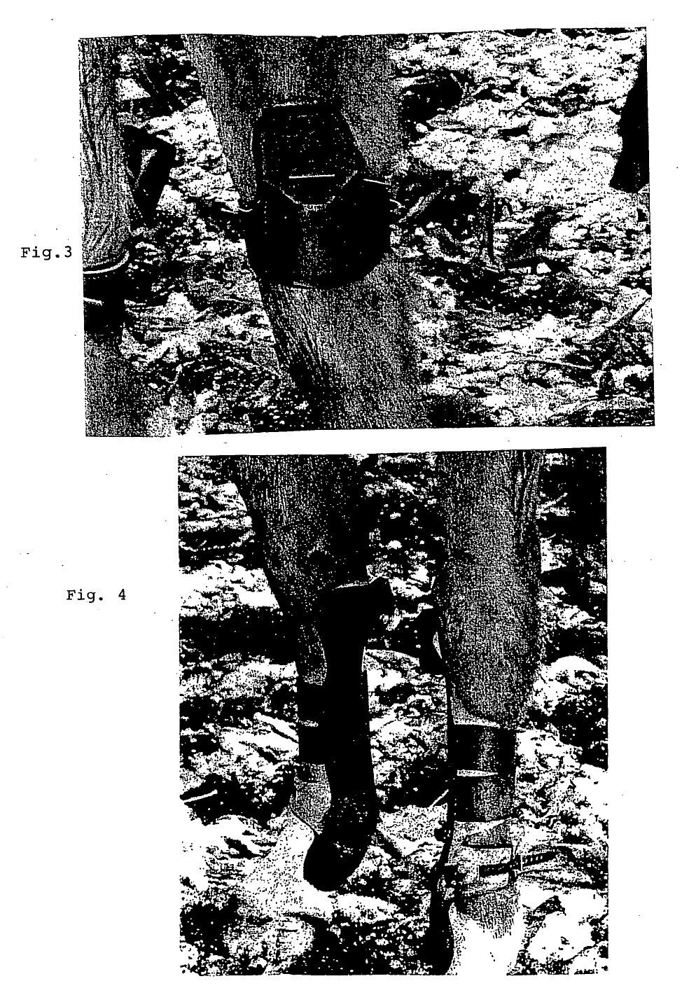

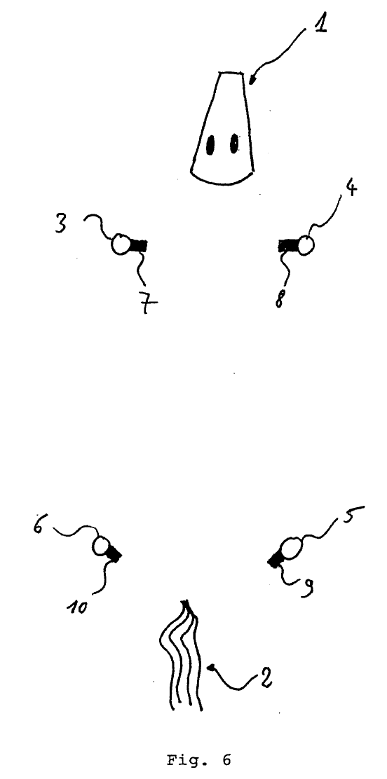

FIGS. 3 and 5 illustrate gaiters similar to that of FIG. 1, which are fixed on fore legs.

The gaiter illustrated in FIG. 2 can advantageously be used for a hind leg. The weight is disposed in the upper part of the gaiter.

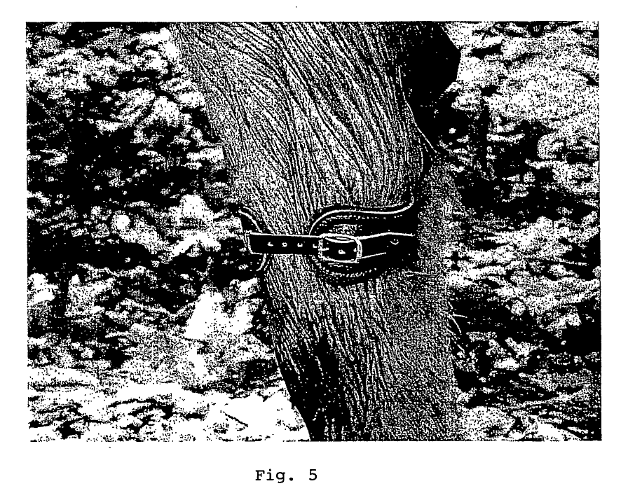

FIG. 4 show hind legs fitted with the gaiters of FIG. 2.

The diagram of FIG. 6 presents a possible arrangement of the gaiters.

It represents the head of the horse 1, the tail 2, the left fore leg 3 and its weight 7, the right fore leg 4 and its weight 8, the right hind leg 5 and its weight 9, the left hind leg 6 and its weight 10.

The weights of the fore gaiters 7, 8 are directed towards the inside and are arranged one opposite the other.

The weights of the hind gaiters 9, 10 are likewise directed towards the inside but point rearward, i.e. at about 4 o'clock for the left hind leg 6 and at about 8 o'clock for the right hind leg 5.

The placement and orientation of the weights can be modified, of course, according to requirements.

It is possible, moreover, to provide a plurality of weights for one and the same gaiter.

Finally, it shall be pointed out that the invention is not confined to a shape or a type of material chosen for the weight. Any shape or material may be chosen which allows the fulfillment of a weight function.

1. A fore posture gaiter for a horse, comprising a weight, characterized in that the gaiter is realized in such a way as to be placed above the knee.

2. The gaiter as claimed in claim 1, characterized in that the weight is disposed on the gaiter in such a way that it is directed according to a predefined orientation when the gaiter is fixed on the horse.

3. The gaiter as claimed in claim 2, characterized in that the weight is disposed on the gaiter in such a way as to be directed towards the inside of the horse.

4. A hind posture gaiter for a horse, comprising a weight, characterized in that the gaiter is realized in such a way that the weight is disposed in the upper part of the gaiter.

5. The gaiter as claimed in claim 4, characterized in that it is realized in such a way as to be fixed below the hock.

6. The gaiter as claimed in claim 4, characterized in that the weight is disposed on the gaiter in such a way that it is directed according to a predefined orientation when the gaiter is fixed on the horse.

7. The gaiter as claimed in claim 6, characterized in that the weight is disposed on the gaiter in such a way as to be directed towards the inside of the horse.

8. A use of a weighted fore posture gaiter for a horse, characterized in that the gaiter is fixed above the knee of the horse.

9. A use of a weighted hind posture gaiter for a horse, characterized in that the gaiter is fixed below the hock.

10. (canceled)

11. The use of a weighted hind posture gaiter as claimed in claim 9, characterized in that the weight is set in the upper part of the gaiter.

12. The gaiter as claimed in claim 5, characterized in that the weight is disposed on the gaiter in such a way that it is directed according to a predefined orientation when the gaiter is fixed on the horse.
